(19) United States
(12) Patent Application Publication
(10) Pub. No.: US 2017/0300101 A1
(43) Pub. Date: Oct. 19, 2017

(54) REDIRECTING MESSAGES FROM IDLE COMPUTE UNITS OF A PROCESSOR

(71) Applicant: Advanced Micro Devices, Inc., Sunnyvale, CA (US)

(72) Inventors: Alexander J. Branover, Boxborough, MA (US); Ashish Jain, Austin, TX (US); Mom Eng Ng, Austin, TX (US)

(21) Appl. No.: 15/099,321

(22) Filed: Apr. 14, 2016

(51) Int. Cl. G06F 1/32; G06F 1/20

(52) U.S. Cl. CPC G06F 1/3203; G06F 1/206; G06F 1/3296

(57) ABSTRACT

A power management module of a processor places a compute unit in a low power mode (e.g., an idle mode) in response to identifying that the compute unit is expected to experience little to no processing activity for a threshold amount of time. In response to receiving an indication from a message controller that a message is targeted to the compute unit, the power management module selects a different compute unit that is presently in an active power mode and provides the message to the selected compute unit for processing. The compute unit can be selected based on any of a variety of criteria, such as the compute unit being in a stall condition, an indication from a performance monitor that the compute unit is executing a relatively inefficient program thread, and the like.

### BACKGROUND

### Field of the Disclosure

The present disclosure relates generally to processors and more particularly to power management for processors.

### Description of the Related Art

A processor is typically constrained to operate within a power budget, wherein the power budget is based on one or more of a variety of factors, such as a target battery life for a battery supplying the processor, thermal limitations to preserve a desired lifespan of the processor, programmable performance settings for the processor, and the like. For a processor including more than one compute unit (e.g., a processor including multiple processor cores), meeting the power budget can be achieved by managing power states of the compute units individually. For example, an operating system executing at the processor can place a compute unit that is experiencing low levels of processing activity into an idle state, whereby the compute unit consumes a relatively small amount of power but is not able to perform useful processing activity. The operating system can return the idle compute unit to an active state in response to identifying that the compute unit is required to perform a processing operation, such as processing of a message from another compute unit that has been targeted to the idle processor core. However, transitions into and out of the idle state can consume an undesirable amount of power and make it difficult to meet the power budget while maintaining a desired level of processing activity at the processor.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor that can redirect messages from an idle processor core targeted by the message to an active processor core for servicing in accordance with some embodiments.

FIG. 2 is a block diagram of an example of the processor of FIG. 1 redirecting a message from an idle processor core targeted by the message to an active but stalled processor core in accordance with some embodiments.

FIG. 3 is a block diagram of an example of the processor of FIG. 1 redirecting a message targeted to an idle processor core to an active but processor core that is experiencing low processing efficiency in accordance with some embodiments.

FIG. 4 is a block diagram of an example of the processor of FIG. 1 transferring the architectural state of an idle processor core to an active processor core to allow the active processor to service a message in accordance with some embodiments.

FIG. 5 is a flow diagram of a method of redirecting a message from an idle processor core targeted by the message to an active but stalled processor core in accordance with some embodiments.

### DETAILED DESCRIPTION

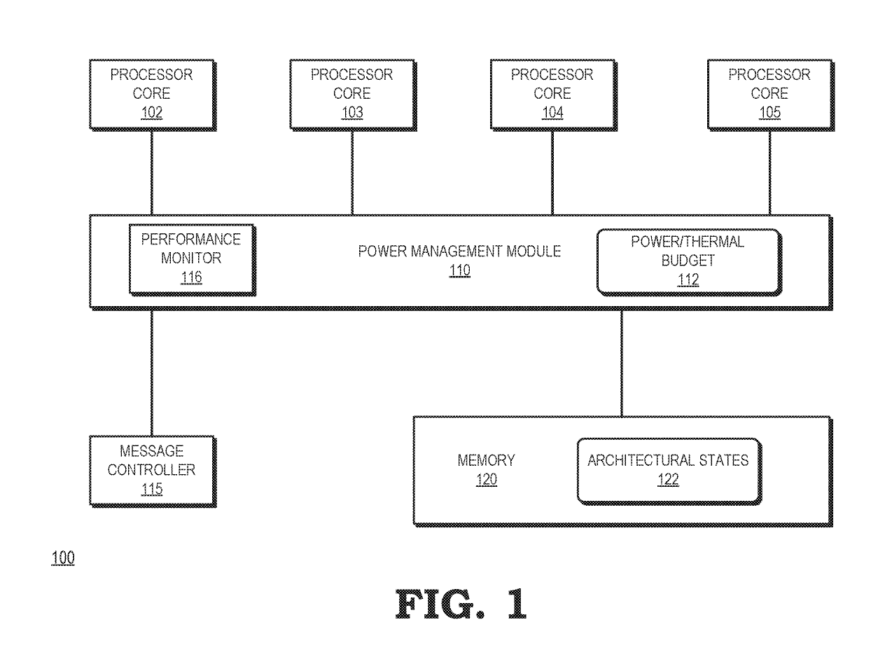

FIGS. 1-5 illustrate techniques for improving power management at a processor by redirecting messages targeted to a compute unit in a low-power mode to an active compute unit for processing. A power management module of the processor places the compute unit in the low power mode (e.g., an idle mode) in response to identifying, for example, that the compute unit is expected to experience little to no processing activity for a threshold amount of time. In response to receiving an indication from a message controller that a message (e.g., an interrupt) is targeted to the compute unit, the power management module selects a different compute unit that is presently in an active power mode and provides the message to the selected compute unit for processing. The compute unit can be selected based on any of a variety of criteria, such as the compute unit being in a stall condition, an indication from a performance monitor that the compute unit is executing a relatively inefficient program thread, and the like. By redirecting messages from the idle compute unit to an active compute unit, the processor avoids transitioning the idle compute unit to an active power mode, thereby conserving power.

FIG. 1 illustrates a block diagram of a processor 100 that can redirect messages from a compute unit in a low-power mode and targeted by the message to an active processor core for servicing in accordance with some embodiments. For purposes of description, it is assumed that the processor 100 is a general purpose processor, such as a central processing unit (CPU) configured to execute sets of instructions organized in the form of computer programs. However, in other embodiments the processor 100 can be a graphics processing unit (GPU), digital signal processor (DSP), application-specific processor, and the like, or can be an accelerated processing unit (APU) that includes different types of processing units, such as a CPU and GPU, in single integrated circuit package. In any of these embodiments, the processor 100 can be incorporated into any of a number of electronic devices, such as a desktop or laptop computer, server, game console, tablet, smartphone, and the like.

The processor 100 includes a plurality of compute units, wherein a compute unit is the unit of computation capable of executing a sequence of commands for the processor 100 under hardware or software control. Examples of compute units include processor cores, GPU compute units, and the like. In the example of processor 100, the compute units are processor cores 102-105. Each of the processor cores 102-105 includes an instruction pipeline having a fetch stage, decode stage, dispatch stage, a plurality of execution units, and a retire stage that together are configured to fetch and execute instructions in a pipelined fashion. For the example of FIG. 1, it is assumed that the processor 100 is a multithreaded processor, wherein the computer programs being executed at the processor 100 are divided into threads, with each thread configured to execute one or more corresponding tasks for its computer program. An operating system (not shown) executing at the processor 100 schedules each thread for execution at one of the processor cores 102-105.

Each of the processor cores 102-105 can be individually and selectively placed in any of a number of power modes, wherein the power modes govern the amount of power supplied to the processor core and the corresponding speed with which the processor core can execute instructions. In some embodiments, the power modes include an active mode, wherein the processor core is supplied a nominal amount of power and executes instructions at a nominal rate, and one or more low-power modes, wherein the processor core is supplied a lower amount of power as compared to the nominal amount, and executes instructions at a lower rate that the nominal rate or, in the case of an idle mode, does not execute instructions.

In the example of FIG. 1, the processor 100 includes a power management module (PMM) 110 to individually set the power mode for each of the processor cores 102-105. In at least one embodiment, the PMM 110 sets the power mode for a given processor core by controlling one or more voltage regulators (not shown) that supply a reference voltage to the processor core, and one or more clock generators (not shown) that supply one or more clock signals to the processor core. The PMM 110 can set the power mode for a processor core based on one or more of a number of criteria, including commands from software (e.g., the operating system) and performance characteristics of the processor core. For example, the PMM 110 includes a performance monitor 116 that can monitor different aspects of performance for each of the processor cores 102-105, such as the average number of instructions executed per cycle (IPC) of the processor core, the number of idle cycles for the processor core for a given amount of time, the cache hit rate for the processor core, the instruction retirement rate for the processor core, and the like. Based on these performance characteristics, the PMM 110 can individually set and adjust the power mode for each of the processor cores 102-105. For example, if the IPC for a processor core falls below a threshold, this can indicate that the thread being executed at the processor core is stalled (e.g., because of fencing operations, synchronization with other threads being executed, and the like) or is memory bounded. In response, the PMM 110 can place the processor core in a low-power mode so that it consumes less power.

In addition, the PMM 110 can set the power modes for the processor cores 102-105 to meet a power/thermal (P/T) budget 112. As used herein, a power/thermal budget can refer to a power budget, a thermal budget, or a combination of both. The P/T budget 112 indicates a specified maximum amount of power that is to be consumed by the processor 100 over a specified amount of time. In some embodiments, the P/T budget 112 is expressed directly in terms of an amount of power. In other embodiments, the budget is expressed in terms of a specified thermal budget, indicating a maximum average temperature the processor 100 is allowed to operate at over the specified amount of time. Expressing the budget in this way can be useful when the primary goal for the P/T budget 112 is to preserve a specified lifespan of the processor 100. In either case, the PMM 110 can measure the power consumed by the modules of the processor 100, the temperature at one or more locations of an integrated circuit incorporating the processor 100, or a combination thereof, and based on these measurements adjust the power modes of the processor cores 102-105 to ensure that the processor 100 does not exceed the P/T budget 112.

As indicated above, the processor cores 102-105 execute threads of computer programs. In many cases, these threads interact with other modules of the processor 100, including threads executing at other processor cores, input/output (I/O) circuitry (not shown) of the processor 100, memory controllers (not shown) of the processor 100, and the like. The threads interact with the other modules via sets of information generally referred to herein as messages. Examples of messages include interrupts, monitor wait (MWAIT) instructions, and the like. In some embodiments, a message can be any wakeup event that would cause a processor core to be awoken from an idle or other low-power state to an active state. The processor 100 includes a message controller 115 that is generally configured to monitor busses, interfaces, and other modules to identify messages at the processor 100. At least some of the messages will be targeted to one of the processor cores 102-105—that is, a message will indicate, via a field of the message or other identifier, that its destination is one of the processor cores 102-105. The message controller 115 provides such messages to the PMM 110.

In response to receiving a message from the message controller 115, the PMM 110 identifies the processor core targeted by the message. If the processor core targeted by the message is in the active state, the PMM 110 provides the message to the processor core for servicing. If the processor core targeted by the message is in one of a set of specified low-power states, the PMM 110 identifies other processor cores that are in the active state, selects one of the other processor cores, and provides the message to the selected processor core for servicing. As described further herein, the PMM 110 can select the processor core based on any of a number of criteria, such as whether the processor core is stalled, performance characteristics of the processor core relative to other processor cores that are in the active mode, and the like. Be redirecting the message to an active, relatively less efficient processor core, the PMM 110 is able to maintain the targeted processor core in the idle (or other low-power) state, thereby avoiding the power costs of transitioning the targeted processor core to the active state. In some embodiments, the PMM 110 redirects messages from an idle processor core only in response to identifying that transitioning the processor core to the active state to service the message would cause, or is predicted to cause, the processor 100 to exceed the power/thermal budget 112.

In some embodiments, a processor core can service a message targeted to another processor core only if it can be placed in similar architectural state as the targeted processor core. Accordingly, the processor 100 includes a memory 120 that stores architectural states 122 for the processor cores 102-105. In response to specified checkpoints for a processor core, such as when a processor core enters the idle mode, the PMM 110 stores the architectural state of the processor core (e.g., the contents of the register file and other state information) to the architectural states 122. The PMM 110 can restore the architectural state to the processor core in response to other specified events, such as the processor core transitioning from the idle state to an active state. In addition, and as explained further below, in response to selecting an active processor core to service a message targeted to a processor core in the idle mode, the PMM 110 can store the architectural state for the selected processor core to the memory 120, then load the architectural state for the targeted processor core to the selected processor core. The selected processor core thereby becomes a logical replica of the targeted processor core, so that the selected processor core services the message in the same way, with the same result, as if it had been processed at the targeted processor core.

After the message has been serviced, the PMM 110 can then store the architectural state for the selected processor core to the memory 120 and, when the targeted processor core exits the idle state, transfer the architectural state from the memory 120 to the targeted processor core. The targeted processor core is thus put into the architectural state it would have had if it had serviced the message. The PMM 110 thereby is able to redirect messages to active processor cores without affecting the servicing of messages.

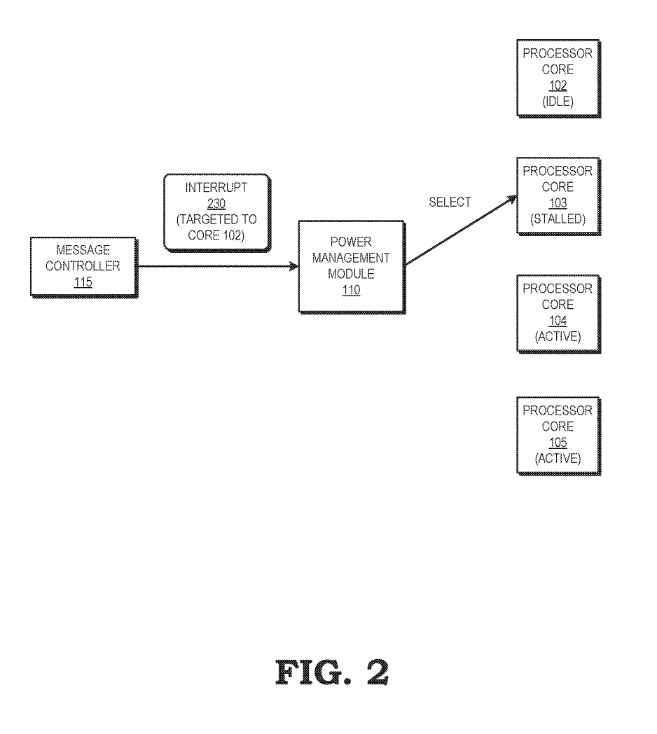

FIG. 2 is a block diagram illustrating an example of the processor 100 redirecting a message targeted to an idle processor core to a stalled but active processor core in accordance with some embodiments. In the illustrated example, the message controller 115 indicates to the PMM 110 an interrupt 230 that is targeted to the processor core 102. The PMM 110 reviews the power mode for the processor cores 102-105, and determines that the processor core 102 is in the idle mode and the processor cores 103-105 are in the active mode. In response, the PMM 110 determines to redirect the interrupt 230 to one of the processor cores 103-105.

To select the processor core for redirection, the PMM 110 reviews the processing status of the threads being executed at each of the processor cores 102-105 and determines that the processor core 102 is in a stalled state. The stalled state can result from any of a number of conditions, such as a data dependency in the thread being executed causing the thread to stall as it awaits processing of the instruction (at a different thread or processor core) upon which an instruction of the thread depends. In some embodiments, the PMM 110 can identify the stalled state of the processor core 102 based on the processor core 102 setting a flag or other identifier that it is stalled while awaiting execution of an instruction of another thread. In other embodiments, the PMM 110 can identify the stalled state of the processor core 102 based on performance characteristics recorded at the performance monitor 116. For example, the PMM 110 can identify that the processor core 102 is in a stalled state in response to the IPC for the processor core 102, as recorded at the performance monitor 116, falling below a threshold value.

In response to identifying that the processor core 102 is in the stalled state, the PMM 110 provides the interrupt 230 to the processor core 102, where the interrupt 230 is serviced. In particular, the processor core 102 services the interrupt in the same fashion, to achieve the same result, as if the interrupt 230 had been serviced at the processor core 102 to which it was originally targeted. The processor core 102 is maintained in the idle state while the interrupt 230 is serviced, thereby conserving power.

In some embodiments, more than one of the processor cores 103-105 may be in the stalled state when the interrupt 230 is received by the PMM 110. The PMM 110 can select from among the stalled processor cores based on any of a variety of criteria, such as the length of time each processor core has been in the stalled state (e.g. selecting the processor core that has been in the stalled state the least amount of time), a confidence value indicating the likelihood that the processor core is in fact in the stalled state, the interrupt handler execution speed among processor cores in the stalled state, and other factors.

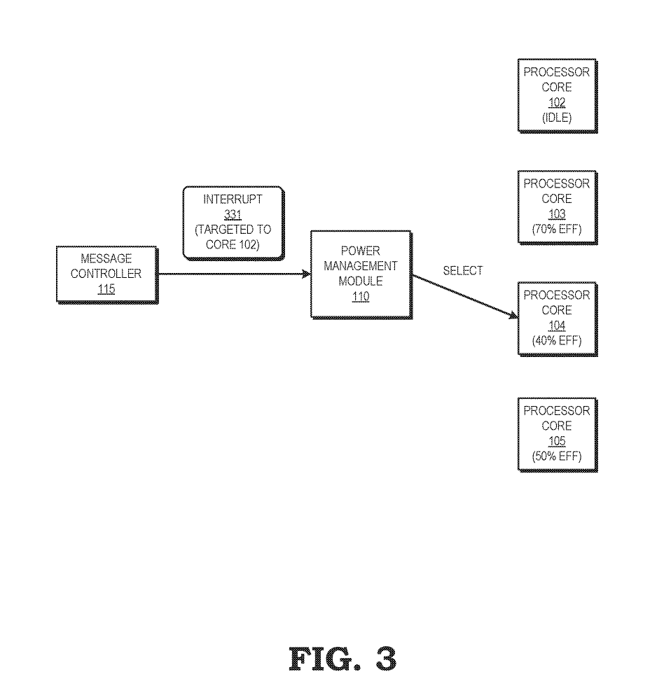

FIG. 3 is a block diagram illustrating an example of the processor 100 redirecting a message targeted to an idle processor core to an active processor core based on a processing efficiency associated with the active processor core in accordance with some embodiments. In the illustrated example, the message controller 115 indicates to the PMM 110 an interrupt 331 that is targeted to the processor core 102. The PMM 110 reviews the power mode for the processor cores 102-105, and determines that the processor core 102 is in the idle mode and the processor cores 103-105 are in the active mode. In response, the PMM 110 determines to redirect the interrupt 331 to one of the processor cores 103-105.

To select the processor core for redirection, the PMM 110 reviews the processing efficiency for the threads being executed at each of the processor cores 102-105. The processing efficiency can be indicated by any of a number of performance characteristics for each processor core, or a combination thereof, as recorded at the performance monitor 116. For example, the processing efficiency can be indicated by the IPC for each processor core, the instruction retirement rate for each processor core, a moving average of the number of idle cycles for each processor core, a moving average of the number of stalls for each processor core, and the like. In the depicted example, the processing efficiency is indicated as a percentage of the number of active or “useful” cycles of execution for the processor core over a specified span of time. However, in other embodiments the processing efficiency for each processor core may be indicated differently, such as by a raw number of idle cycles or other value.

In the depicted example, the processor core 104 has the lowest processing efficiency value, indicating that the thread it is executing is the least efficient of the threads being executed at active processor cores. In response to identifying that the processor core 104 has the lowest processing efficiency, the PMM 110 provides the interrupt 331 to the processor core 104 for servicing while the processor core 102 is maintained in the idle state.

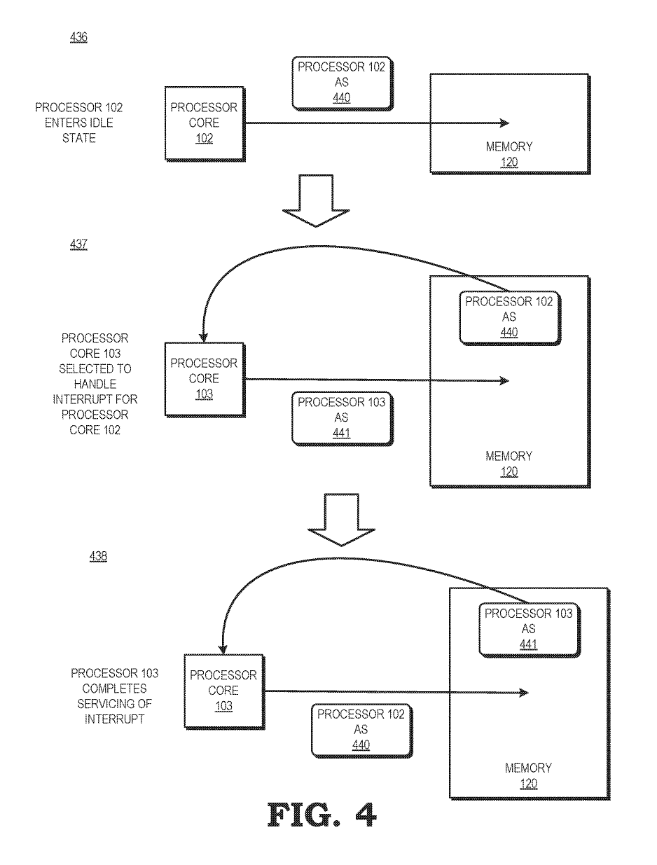

FIG. 4 depicts a block diagram of an example of the processor 100 transferring architectural state of an idle processor to an active processor to support redirection of a message targeted to the idle processor in accordance with some embodiments. In the illustrated example, at a time 436 the PMM 110 transitions the processor core 102 from the active state to the idle state. The transition may be in response to an explicit command from an operating system or other software, based on performance characteristic thresholds being met, and the like, or a combination thereof. As part of the transition, the PMM 110 copies the architectural state information for the processor core 102, designated architectural state (AS) 440, to the memory 120.

At a subsequent time 437, the PMM 110 determines to redirect an interrupt targeted to the processor core 102, still in the idle state, to the processor core 103 for servicing. In response, the PMM 110 stores the architectural state information for the processor core 103, designated architectural state 441, to the memory 120. The PMM 110 then loads the architectural state 440 to the processor core 103. The processor core 103 is thereby made logically equivalent to the processor core 102. The processor core 103 then services the interrupt as if it were being serviced at the processor core 102 to which it was originally targeted.

At a subsequent time 438, the PMM 110 identifies that the processor core 103 has completed servicing of the interrupt. In response, the PMM 110 causes the processor core 103 to store the architectural state 440 to the memory 120. This architectural state 440 may have been modified based on the servicing of the interrupt. The PMM 110 then loads the architectural state 441 to the processor core 103, thereby returning the processor core 103 to its state prior to servicing the interrupt and allowing the processor core 103 to continue executing any thread it was executing prior to servicing the interrupt.

At a later time (not shown at FIG. 4), the processor core 102 can transition from the idle state to the active state. In response, the PMM 110 loads the architectural state 440 to the processor core 102. As indicated above, the architectural state 440 may have been modified as part of the servicing of the interrupt by the processor core 103. Thus, the processor core 102 is placed into the state it would have had if it had serviced the interrupt, thereby rendering the redirection of the interrupt invisible to any software being executed at the processor 100.

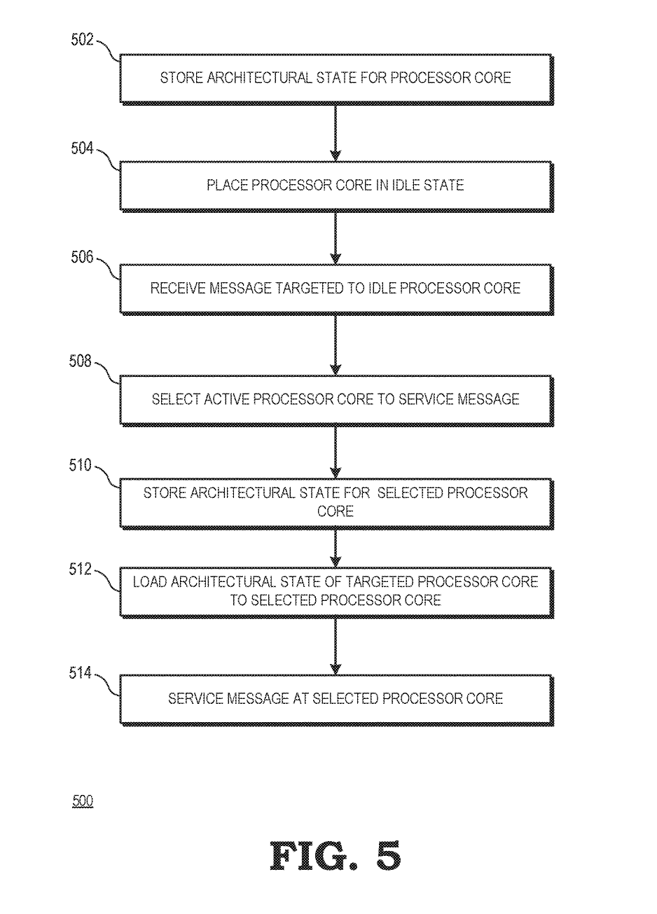

FIG. 5 illustrates a block diagram of a method 500 of redirecting a message targeted to a compute unit in a low-power state in accordance with some embodiments. For purposes of description, the method 500 is described with respect to an example implementation at the processor of FIG. 1. At block 502, the PMM 110 determines that the processor core 103 is to enter an idle state and, in response, copies the architectural state for the processor core 103 to the memory 120. At block 504, the PMM 110 places the processor core 103 into the idle state.

At block 506 the PMM 110 receives a message from the message controller 115, wherein the message is targeted to the processor core 103. In response to identifying that the processor core 103 is in the idle state, at block 508 the PMM 110 selects an active processor core to service the message. At block 510 the PMM 110 stores the architectural state for the selected processor core to the memory 120 and, at block 512, the PMM 110 loads the architectural state for the idle processor core 103 to the selected processor core. At block 514, the selected processor core services the message while the processor core 103 is maintained in the idle state, thereby conserving power at the processor 100.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving a message targeted to a first compute unit of a plurality of compute units, and in response to the first compute unit being in a low-power state:
selecting a second compute unit of the plurality of compute units;
loading an architectural state of the first compute unit to the second compute unit; and
servicing the message at the second compute unit while maintaining the first compute unit in the low-power state; and.

2. The method of claim 1, further comprising:
storing the architectural state of the first compute unit from the first compute unit to memory when placing first compute unit in the low-power state; and
wherein loading the architectural state of the first compute unit to the second compute unit comprises loading the architectural state to the second compute unit from the memory.

3. The method of claim 2, further comprising:
saving an architectural state of the second compute unit to the memory prior to loading the architectural state of the first compute unit to the second compute unit.

4. The method of claim 1, wherein selecting the second compute unit comprises selecting the second compute unit in response to identifying that placing the first compute unit in an active state will exceed a specified thermal budget for the plurality of compute units.

5. The method of claim 1, wherein selecting the second compute unit comprises selecting the second compute unit in response to the second compute unit being in an active state.

6. The method of claim 1, wherein selecting the second compute unit comprises selecting the second compute unit based on a processing efficiency associated with a thread being executed at the second compute unit.

7. The method of claim 1, wherein selecting the second compute unit comprises selecting the second compute unit in response to identifying a stall at the second compute unit.

8. The method of claim 1, wherein the first message comprises an interrupt.

9. The method of claim 1, wherein the first message comprises a monitor wait (MWAIT) instruction.

10. A method, comprising
placing a first compute unit of a processor in an idle state; and
in response to receiving a message targeted to the first compute unit while in the idle state, and in response to identifying that placing the first compute unit in an active state will exceed a power budget for the processor, redirecting the message to a second compute unit of the processor for servicing.

11. The method of claim 10, wherein redirecting comprises loading an architectural state of the first compute unit to the second compute unit.

12. The method of claim 10, wherein servicing the message at the second compute unit comprises servicing the message at the second compute unit in response to the second compute unit being in an active state.

13. A processor comprising:
a plurality of compute units including a first compute unit and a second compute unit;
a power management module to receive a message targeted to the first compute unit and to redirect the first message to the second compute unit responsive to the first compute unit being in a low-power state; and
wherein the second compute unit is to service the message at the second compute unit while the first compute unit is maintained in the low-power state.

14. The processor of claim 13, wherein the power management module is to:
load an architectural state of the first compute unit to the second compute unit.

15. The processor of claim 14, wherein the processor is to:
store the architectural state of the first compute unit from the first compute unit to memory when placing first compute unit in the low-power state; and
wherein the power management module is to load the architectural state of the first compute unit to the second compute unit by loading the architectural state to the second compute unit from the memory.

16. The processor of claim 15, wherein the power management module is to:
save an architectural state of the second compute unit to the memory prior to loading the architectural state of the first compute unit to the second compute unit.

17. The processor of claim 13, wherein the power management module is to select the second compute unit to service the first message in response to identifying that placing the first compute unit in an active state will exceed a specified thermal budget for the plurality of compute units.

18. The processor of claim 13, wherein the power management module is to select the second compute unit to service the first message in response to the second compute unit being in an active state.

19. The processor of claim 13, wherein the power management module is to select the second compute unit to service the first message based on a processing efficiency associated with a thread being executed at the second compute unit.

20. The processor of claim 13, wherein the power management module is to select the second compute unit to service the first message in response to identifying a stall at the second compute unit.
